(19) United States
(12) Patent Application Publication
(10) Pub. No.: US 2008/0075433 A1
(43) Pub. Date: Mar. 27, 2008

(54) LOCATING DIGITAL IMAGES IN A PORTABLE ELECTRONIC DEVICE

(75) Inventor: Mats GUSTAFSSON, Nacka (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/534,489

(22) Filed: Sep. 22, 2006

(51) Int. Cl. H04N 7/00

(52) U.S. Cl. 386/96

(57) ABSTRACT

The present invention provides systems and methods for the creation and use of voice tags in an electronic device. When tags are created an image handling unit receives a user selection of a voice tag that may be provided for locating at least one digital image, a sound recording unit records sound emitted by said user, which sound is stored as a sound file to be used as a tag for locating images. When image files are to be located the image handling unit receives the selection of searching for digital images using name tags from the user, the sound recording unit records sound emitted by said user, a voice recognition unit compares the sound with stored sound files and indicates a sound file corresponding to the received sound. The image file associated with the indicated sound file is then located.

### TECHNICAL FIELD OF THE INVENTION

The present invention generally relates to locating stored digital images and, more particularly, to a method and system for simplifying the locating of digital images stored in an electronic device, such a portable communication device.

### DESCRIPTION OF RELATED ART

Cameras and other image capturing devices have increasingly become smaller and are often present in portable electronic devices, like cellular phones. The available memory space of portable electronic devices has been increasing rapidly recently, such that many captured images may be digitally stored in the devices. It is typically possible to transfer stored images to/from portable electronic devices, for instance using messages, like MMS messages and e-mail messages. Managing a large number of stored images for these and other purposes (e.g., viewing) may be cumbersome.

In computer devices, image handling applications exist in which a user can enter text via a keyboard as a tag or label that identifies an image and which may be used to locate the stored image in the memory. However, a portable electronic device is small and typically has a keypad instead of a keyboard. In keypad use, a single key is often used to represent multiple input characters/symbols, thereby complicating the entry of the identifier to be used in locating the associated digital image.

It would be beneficial to simplify the designation of identifiers (e.g., tags, labels, etc.) in relation to digital images stored in an electronic device.

### SUMMARY OF THE INVENTION

Implementations of the present invention are directed to providing a method and system for locating digital images in a portable electronic device.

According to one implementation, method of image management in a portable electronic device includes receiving, from a user, a selection of a voice tag to be associated with at least one image in an image file storage, recording a first sound received from the user, and storing the first sound as a sound file to be used as the voice tag for locating the at least one image.

Additionally, the method may include associating the sound file with the at least one image.

Additionally, the associating may include storing the association between the sound file and the at least one image in a table.

Additionally, the method may include automatically naming the sound file, wherein the association comprises storing the file names of the at least one image and the sound file in the table.

Additionally, the method may include receiving, from the user, a selection of an audible search of the image file storage; recording a second sound received from the user; comparing the second sound with the stored sound file; determining a correspondence between the second sound and the stored sound file; and locating the at least one image in the image file storage based on the correspondence determination.

Additionally, the locating may include locating the at least one image by using a table comprising associations between sound files and image files.

Additionally, the method may include sending at least the sound files to an external image handling entity together with associated stored images.

According to another implementation, an electronic device may include: a microphone; a tactile user input unit; a sound recording unit; a number of digital images; and a digital image handling unit. The digital image handling unit may be configured to receive, via the tactile user input unit, a user selection of a voice tag that may be provided for locating at least one digital image, instruct said sound recording unit to record sound received from said user via said microphone, and store said recorded sound as a sound file to be used as a tag for locating at least one image among the number of digital images.

Additionally, the digital image handling unit may be further configured to associate the sound file with at least one user selected image.

Additionally, the electronic device may include an association table, wherein the digital image handling unit may be further configured to store the association between the sound file and the digital image in the table.

Additionally, the digital image handling unit may be further configured to automatically name the sound file and store the file name of the associated image and sound files in the table.

Additionally, the electronic device may include a voice recognition unit, wherein the digital image handling unit may be further configured to receive, via the tactile user input unit, a user selection of searching for digital images using voice tags, instruct the sound recording unit to record sound emitted by the user via the microphone, instruct the voice recognition unit to compare the sound with stored sound files and indicate a sound file corresponding to the received sound, and locate at least one image file associated with the indicated sound file.

Additionally, the digital image handling unit may be further configured to locate an image file through investigating an association table comprising associations of sound files to image files for the identified sound file.

Additionally, the electronic device may include a communication unit, wherein the digital image handling unit may be further configured to export at least the sound files to an external image handling entity together with associated digital images.

Additionally, the electronic device may be a portable communication device.

Additionally, the electronic device is a mobile phone.

According to another implementation, device for locating digital images may include means for receiving a user selection of a voice tag that may be provided for means for locating at least one digital image, means for recording sound emitted by the user, and means for storing the sound as a sound file to be used as a tag for locating images.

According to another implementation, a computer program for enabling the locating of digital images in a portable electronic device may include computer program code to instruct the portable electronic device to: receive a user selection of a voice tag that may be provided for locating at least one digital image, cause said sound recording unit to record sound emitted by said user via a microphone, and store said sound as a sound file to be used as a tag to be used for locating images.

According to another implementation, a method for simplifying the locating of digital images in a portable electronic device may include receiving from a user the selection of searching for digital images using name tags; recording sound emitted by said user; comparing said sound with stored sound files; indicating a sound file corresponding to the received sound; and locating at least one image file associated with the indicated sound file.

According to another implementation, an electronic device may include a microphone; a voice recognition unit; a tactile user input unit; a sound recording unit; a number of digital images; and a digital image handling unit. The digital image handling unit may be configured to receive from a user, via the tactile user input unit, the selection of searching for digital images using voice-tags, instruct the sound recording unit to record sound emitted by the user via the microphone, instruct the voice recognition unit to compare the received sound with stored sound files and indicate a sound file corresponding to the received sound, and locate at least one image file associated with the indicated sound file.

According to another implementation, a portable electronic device for simplifying the locating of digital images may include: means for receiving from a user the selection of searching for digital images using name tags, means for recording sound emitted by the user, means for comparing the sound with stored sound files, means for indicating a sound file corresponding to the received sound, and means for locating at least one image file associated with the indicated sound file.

According to yet another implementation, computer program for enabling the locating of digital images in a portable electronic device may include computer program code to cause the portable electronic device to: receive, from a user, the selection of searching for digital images using name tags; instruct a sound recording unit to record sound emitted by the user via a microphone, instruct a voice recognition unit to compare the received sound with stored sound files and indicate a sound file corresponding to the received sound, and locate at least one image file associated with the indicated sound file.

Implementations of the present invention have many advantages. With the present invention it is possible to easily retrieve and view images without a user having to perform extensive navigation and especially without having to manually enter names of tags, which is often burdensome. A user may say words that are used as tags to images. Thus a user may freely select the sound that is to be used for locating images. The user will then only have to speak a word and the images associated with the word are found. The invention is therefore very user friendly.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 shows a front view of a portable electronic device as a mobile phone;

FIG. 2 shows a block schematic of different units provided in the phone of FIG. 1 for implementing the present invention;

FIG. 3 schematically shows a screen provided by a digital image handling unit of the present invention;

FIG. 4 schematically shows an association table mapping sound files to image files;

FIG. 5 shows a flow chart of an exemplary method of creating voice tag;

FIG. 6 is a flow chart of an exemplary method of locating images using voice tags; and

FIG. 7 schematically shows a computer program product in the form of a CD ROM disc comprising computer program code for practicing exemplary implementations.

### DETAILED DESCRIPTION OF EMBODIMENTS

The present invention relates to an electronic device having file management functionality.

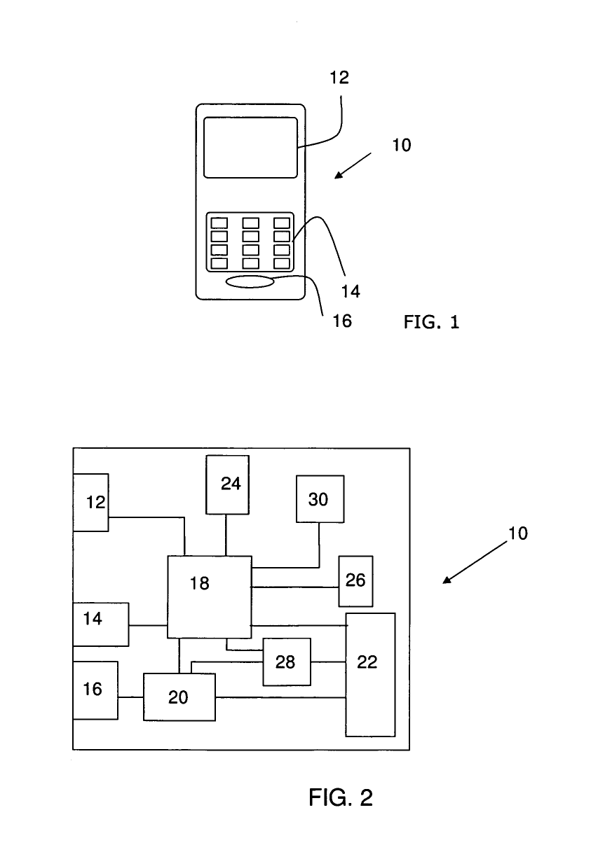

In FIG. 1, there is shown a front view of a portable electronic device in the form of a portable communication device, and particularly in the form of a mobile phone 10. Phone 10 includes image handling functionality, which will be described in more detail later. Phone 10 may include a display 12 and a set of tactile user input units, for example, in the form of a number of keys on a keypad 14, via which a user may control the image management functionality. Phone 10 may include a microphone 16 that may receive sound from a user of phone 10. A mobile phone is just one example of a portable electronic device according to the present invention. The invention is in no way limited to this type of device, but can be applied on other types of portable communication devices, for instance a smartphone and a communicator or other portable electronic devices like a lap top computer, a palm top computer, electronic organizer or image viewer, or other type of handheld device.

FIG. 2 shows a functional diagram as a block schematic of modules or units in phone 10. Phone 10 may include display 12, keypad 14 and microphone 16, where microphone 16 may be connected to a sound recording unit 20. Sound recording unit 20 may, in turn, be connected to a sound file store 22 and to a voice recognition unit 28, which voice recognition unit 28 may also be connected to the sound file store 22. Voice recognition unit 28 may be a typical type of voice recognition unit that is normally used in phones in relation to dialing phone numbers. An image handling application may be provided by a digital image handling unit 18, which may be connected to display 12, keypad 14, sound recording unit 20, sound file store 22, voice recognition unit 28, sound file store 22 and/or image store 24. Digital image handling unit 18 may also be connected to an association table 26, as well as to a communication unit 30, which communication unit 30 can be an interface for connection to a computer like a PC, for instance, in the form of a USB port.

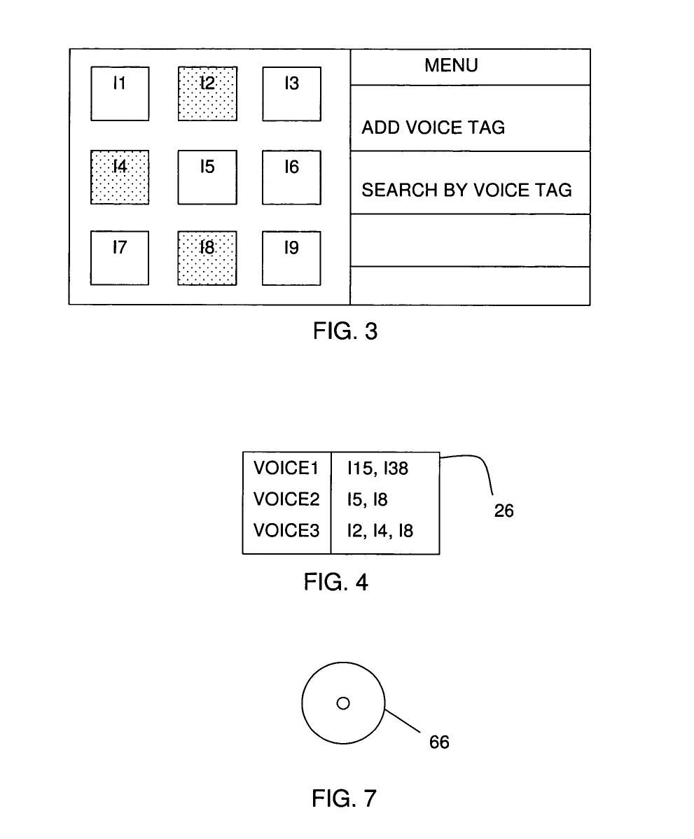

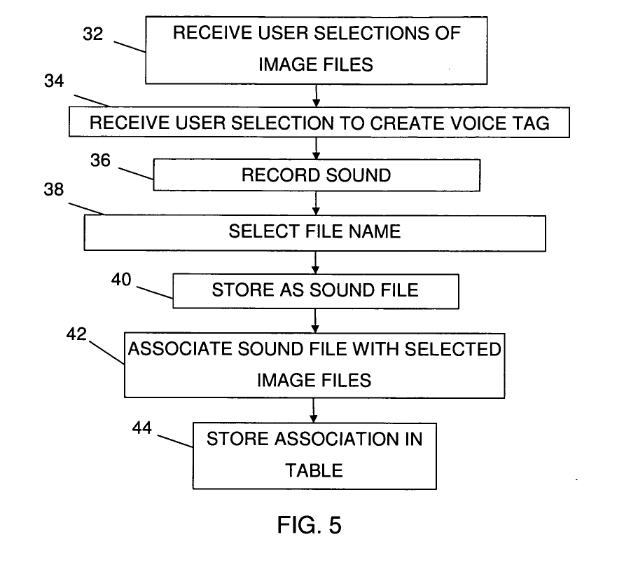

The creation of voice tags according to the principles of the present invention will now be described with reference being made to FIGS. 1 and 2, as well as to FIG. 3, which shows a screen provided by digital image handling unit 18 on display 12, to FIG. 4, which shows an association table 26 mapping sound files to image files, as well as to FIG. 5, which shows a flow chart of a method of enabling simplifying the locating of digital images. The exemplary method may also be termed a method of creating voice tags.

Phone 10 may be provided with a camera (not shown) or other device configured to capture images. Captured images may be stored in image store 24. It is also possible that phone 10 may receive images from other entities such as via wireless communication, either locally, for instance using BLUETOOTH, for example, or globally using a wireless network. Phone 10 may also directly connect with a computer and receive images from it. Images may be obtained by attachment of a removable memory storage, such as a memory stick to the phone. Phone 10 may obtain digital images from a variety of sources.

The number of stored images may be very large and a need may exist to organize the stored images such that a user of phone 10 is allowed to retrieve the stored images in an efficient manner. Digital image handling unit 18 may provide such an image handling functionality. Image handling functionality may be accessed by a user from the menu system of phone 10 and may be selected, for example, by a user by making selections via keypad 14. Keypad 14 may include soft keys and/or a joystick or other device that simplifies the navigation (e.g., scrolling, etc.) of the menu.

In one implementation, as a user starts the image handling application provided by image handling unit 18, image handling unit 18 may present a start-up view to the user on display 12, an exemplary view of which is presented in FIG. 3. For example, the user may be presented with thumbnail versions of images I1, I2, I3, I4, I5, I6, I7, I8 and I9 from image store 24, and a menu having menu items associated with the displayed images is shown. The menu items may be selected by the user. In FIG. 3, only two such available menu items “add voice tag” and “search by voice tag” are shown for clarity of discussion. It should be appreciated that more selectable items may be provided by the menu.

A user may select a number of displayed images for which a voice tag is to be added. User selection may be accomplished using, for instance, a joystick, a soft key, or some other key of keypad 14, to select one or more displayed images which are to be tagged. In FIG. 3, it is indicated that such a selection has been made by the user for images I2, I4, and I8. The selections may be received by image handling unit 18 (step 32). Thereafter, the user may select the “add voice tag” entry from the menu, via suitable keys of keypad 14, for example. The user selection may be received by image handling unit 18 (step 34).

Image handling unit 18 may activate sound recording unit 20, and instruct sound recording unit 20 to record sound received via microphone 16. As the user then speaks, for instance, by saying a word like the word “vacation,” the received sound may then be recorded by sound recording unit 20 (step 36). Sound recording unit 20 may be provided with suitable speech coding software, such as AMR. Image handling unit 18 thereafter may automatically select a file name to be used for the recorded sound (step 38), where the file name may be the first available name provided in a file name number series, for example. Here, this is indicated by the names, voice1, voice2 and voice3. As an example, it is here assumed that if the file name selected is voice3, i.e., that the files, voice1 and voice2, have already been created and used. Image handling unit 18 may then instruct sound recording unit 20 to store the recorded sound as file voice3 in sound file store 22 (step 40). Image handling unit 18 thereafter may associate the sound file, voice3, with the selected image files I2, I4, and I8 (step 42), and may store the association in association table 26 (step 44). The association may be made by storing the file name of the sound file and the corresponding image files in the table as is indicated in FIG. 4, which shows a first sound file, voice1, being associated with image files I15 and I38, a second sound file, voice2, being associated with image files I5 and I6, and said sound file, voice3, being associated with image files I2, I4, and I8. Table 26 may not include any actual files, but may only include file names or other referent, for example, to allow an indexed search, for example, using a table.

Voice tags may be created as described above. It should be appreciated that a voice tag need not be created at the same time as an image is selected for being associated with the voice tag. A voice tag may be created beforehand or later selected to be associated with an image file. Thus, the menu of FIG. 3 may, for instance, provide items “select voice tag” and “create new voice tag” after the item “add voice tag” has been selected, to associate an existing sound file with an image file or to create a new sound file in accordance with the description above. It should be appreciated that more than one voice tag may be associated with an image. That is, a single image may be identified by multiple voice tags. In addition, a single voice tag may be associated with more than one (e.g., a group of) image(s).

With such created voice tags, it is then possible to readily search for and retrieve images from image store 24. The associated voice tags may be used for all manner of managing the stored images.

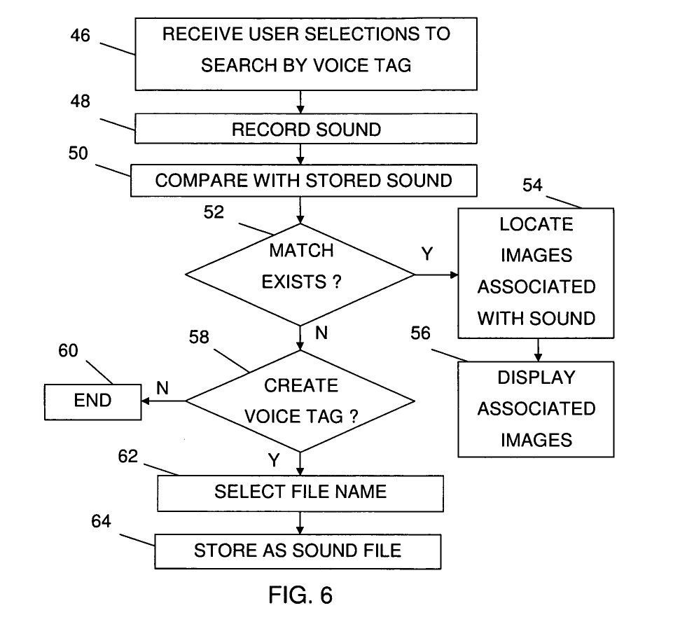

Locating tagged images using the created voice tags will now be described with reference being made to the previously mentioned FIGS. 1-4, as well as to FIG. 6, which shows a flow chart of a method of locating of stored digital images, for example, using voice tags.

Processing may begin by a user selecting the “search by voice tag” entry from the menu shown in FIG. 3, which selection may be received by image handling unit 18 via, for example, the keypad 14 in the above described manner (step 46). Image handling unit 18 may then activate sound recording unit 20 and instruct it to record sound from microphone 16 (step 48), which sound may be the user saying some suitable words like, for instance, the above described word “vacation.” The recorded sound may then be provided to voice recognition unit 28 which may be instructed by image handling unit 18 to compare the recorded sound with previously stored sound files, for example, using ordinary voice recognition techniques (step 50). If voice recognition unit 28 identifies a matching file in sound file store 22, it may indicate this or notify image handling unit 18 of the match by informing image handling unit 18 of the file name of identified sound file (step 52), whereupon image handling unit 18 may locate the image associated with the sound file (step 54). This may be accomplished by image handling unit 18 determining what associations exist for the sound file in table 26. If, as an example, the sound file, voice3, were to be indicated, image handling unit 18 can then directly determine that images I2, I4, and I8 are associated with the sound file. Image handling unit 18 may thereafter present one or more of the images on display 12 (step 56). It should be appreciated that the images need not be displayed all at once. It is, for instance, possible to display singly, or in groups of two or more, for example, in a slide show or any other type of display.

In the event that no match of the recorded voice is identified (step 52), image handling unit 18 may be informed of the determination by voice recognition unit 28 (step 52). Then the user may be invited to create a new voice tag (step 58). If the user declines the invitation, the method may be ended (step 60). If the user accepts the invitation, a file name may be selected (step 62), and the recorded voice stored as a sound file (step 64). This may be performed in the manner described above.

It should appreciated that it may be possible to search for stored images by more than one voice tag. The user may here select several voice tags essentially at the same time or be invited to or select to make a refined search after the images have been located from the original search (i.e., including the several voice tags).

In practicing implementations of the present invention, it is possible to perform retrieval and viewing of images with limited navigation, and without having to manually enter names of tags, for example, which may be burdensome since a keypad may be used to represent several characters. Spoken words may be used as voice tags to label images. Thus, a user may readily enter a sound that may be associated with stored images. The user may then only have to speak a word and the images associated with the word may be located. The invention is easy to implement in a device, such as a phone, because many of the different functions may already be provided. Thus, minimal costs may be involved in implementing the present invention. It can in this case be implemented through providing software implementing the image handling unit.

According to the present invention, it is furthermore possible that images, sound files and table entries may be exported to another external entity like a PC having image handling functionality. They may here be synchronized with a corresponding function on such a PC. In this case, the sound files may be selected and played on the PC so that the user may hear the sound files via the PC. Optionally, the user may here be able to change the name of the sound file, which name change may then also be provided in the phone at later synchronizations. In this way, it is possible for the user to also name the file according to a spoken word selected by the user. Editing of sound files and image file names may be performed at a PC rather than at a small portable electronic device, for example. The communication for exporting this information to a PC may here be performed using communication unit 30, shown in FIG. 2. It should be appreciated that the name of the sound file may of course also be changed via the phone.

The image handling unit may be provided in the form of one or more processors together with a program memory store containing program code for performing the functions of this unit. The other entities may be functional entities that are well known from the field of cellular phones. The program code can also be provided on a computer program product, like a CD ROM disc, a memory stick or another suitable data carrier, which performs the invention when being loaded into the device. One such medium is schematically shown in FIG. 7, which shows a CD ROM disc 66, on which the program code for the phone may be provided. The program code may furthermore be provided on an external server and downloaded from there into the phone.

Therefore the present invention is only to be limited by the following claims.

What is claimed is:

1. A method of image management in a portable electronic device, comprising:
receiving, from a user, a selection of a voice tag to be associated with at least one image in an image file storage,
recording a first sound received from the user, and
storing the first sound as a sound file to be used as the voice tag for locating the at least one image.

2. The method of claim 1, further comprising:
associating the sound file with the at least one image.

3. The method of claim 2, wherein associating comprises:
storing the association between the sound file and the at least one image in a table.

4. The method of claim 3, further comprising:
automatically naming the sound file, wherein the association comprises storing the file names of the at least one image and the sound file in the table.

5. The method of claim 1, further comprising:
receiving, from the user, a selection of an audible search of the image file storage;
recording a second sound received from the user;
comparing the second sound with the stored sound file;
determining a correspondence between the second sound and the stored sound file; and
locating the at least one image in the image file storage based on the correspondence determination.

6. The method of claim 5, wherein locating comprises:
locating the at least one image by using a table comprising associations between sound files and image files.

7. The method of claim 1, further comprising:
sending at least the sound files to an external image handling entity together with associated stored images.

8. An electronic device comprising:
a microphone;
a tactile user input unit;
a sound recording unit;
a number of digital images; and
a digital image handling unit configured to
receive, via the tactile user input unit, a user selection of a voice tag that may be provided for locating at least one digital image,
instruct said sound recording unit to record sound received from said user via said microphone, and
store said recorded sound as a sound file to be used as a tag for locating at least one image among the number of digital images.

9. The electronic device of claim 8, wherein said digital image handling unit is further configured to associate the sound file with at least one user selected image.

10. The electronic device of claim 9, further comprising:
an association table, wherein said digital image handling unit is further configured to store the association between the sound file and the digital image in said table.

11. The electronic device of claim 10, wherein said digital image handling unit is further configured to automatically name the sound file and store the file name of the associated image and sound files in said table.

12. The electronic device of claim 8, further comprising:
a voice recognition unit, wherein said digital image handling unit is further configured to
receive, via the tactile user input unit, a user selection of searching for digital images using voice tags,
instruct said sound recording unit to record sound emitted by said user via said microphone,
instruct the voice recognition unit to compare said sound with stored sound files and indicate a sound file corresponding to the received sound, and
locate at least one image file associated with the indicated sound file.

13. The electronic device of claim 12, wherein the digital image handling unit is further configured to locate an image file through investigating an association table comprising associations of sound files to image files for the identified sound file.

14. The electronic device of claim 8, further comprising a communication unit, wherein said digital image handling unit is further configured to export at least the sound files to an external image handling entity together with associated digital images.

15. The electronic device of claim 8, wherein the electronic device is a portable communication device.

16. The electronic device of claim 15, wherein the electronic device is a mobile phone.

17. A device for locating digital images, comprising:
means for receiving a user selection of a voice tag that may be provided for means for locating at least one digital image,
means for recording sound emitted by said user, and
means for storing said sound as a sound file to be used as a tag for locating images.

18. A computer program for enabling the locating of digital images in a portable electronic device comprises computer program code to instruct the portable electronic device to:
receive a user selection of a voice tag that may be provided for locating at least one digital image,
cause said sound recording unit to record sound emitted by said user via a microphone, and
store said sound as a sound file to be used as a tag to be used for locating images.

19. A method for simplifying the locating of digital images in a portable electronic device, the method comprising:
receiving from a user the selection of searching for digital images using name tags;
recording sound emitted by said user;
comparing said sound with stored sound files;
indicating a sound file corresponding to the received sound; and
locating at least one image file associated with the indicated sound file.

20. An electronic device comprising:
a microphone;
a voice recognition unit;
a tactile user input unit;
a sound recording unit;
a number of digital images; and
a digital image handling unit configured to:
receive from a user, via the tactile user input unit, the selection of searching for digital images using voice tags,
instruct said sound recording unit to record sound emitted by said user via said microphone,
instruct the voice recognition unit to compare the received sound with stored sound files and indicate a sound file corresponding to the received sound, and
locate at least one image file associated with the indicated sound file.

21. A portable electronic device for simplifying the locating of digital images, the portable electronic device comprising:
means for receiving from a user the selection of searching for digital images using name tags,
means for recording sound emitted by said user,
means for comparing said sound with stored sound files,
means for indicating a sound file corresponding to the received sound, and
means for locating at least one image file associated with the indicated sound file.

22. A computer program for enabling the locating of digital images in a portable electronic device, comprising computer program code to cause the portable electronic device to:
receive, from a user, the selection of searching for digital images using name tags;
instruct a sound recording unit to record sound emitted by said user via a microphone,
instruct a voice recognition unit to compare this received sound with stored sound files and indicate a sound file corresponding to the received sound, and
locate at least one image file associated with the indicated sound file.
